(19) United States
(12) Patent Application Publication
(10) Pub. No.: US 2012/0296759 A1
(43) Pub. Date: Nov. 22, 2012

(54) ONLINE MARKET FOR RETAIL GOODS

(76) Inventor: Scott SHECHTMAN, New York, NY (US)

(21) Appl. No.: 13/109,621

(22) Filed: May 17, 2011

(51) Int. Cl. G06Q 30/00

(52) U.S. Cl. 705/26.3

(57) ABSTRACT

Systems and methods are provided for creating a dynamic, exchange-like online market for retail goods. The online market receives quotations from a seller to sell a quantity of an item and buy orders from buyers to purchase the items. The price per item from each seller is calculated and the buyers are provided with a ranking of the available items. Furthermore, a buyer may request a ranking of resting sell orders or a seller may request a ranking of resting buy orders. Furthermore, the rankings provided to the buyers may be a function of both the quotations to sell from the seller of an item and available gift cards available.

### DESCRIPTION OF RELATED ART

The World Wide Web provides a convenient mechanism for marketing and selling products. Many websites offer products for sale. Generally a potential customer viewing such a website indicates a desire to purchase a particular product by “clicking” on a particular location on the display screen. By clicking on a link an item may be placed in a Shopping Cart. Some sites require a user to “register” by giving a name, address, and credit card information. Later, when the user desires to buy a product, information entered during registration is used for billing and shipping. Some sites allow a user to enter billing and shipping information after the user has indicated the desire to purchase a particular product.

Some websites allow multiple bidders to bid on products at auction. As in face-to-face auctions, the bidder with the most beneficial bid to the seller wins the auction and purchases the product. Some websites allow a user to make an offer to buy a product at a specific price, much as an individual might make an offer to buy a product in a face-to-face situation.

In essence, the websites described above utilize the World Wide Web to automate a conventional buying process. The process takes place at great speed and the parties may be remote, but the fundamental transaction is the same as what takes place in a conventional purchase and sale.

Also known are electronic exchanges where financial instruments are traded. These exchanges receive offers for sale and bids to purchase instruments from market participants. Generally, bids and offers are arranged as these exchanges in order at price, with the lowest priced offer to sell and the highest priced bid to buy the instrument defining a “market” price. By allowing market participants to compete, the best bid or offer (BBO) price is arrived at through price discovery.

In addition, bids and offers that are less desirable than the BBO are stored by the exchange so that, when the instrument at the BBO price has been completely traded, a buyer or seller can purchase or sell the instrument at a next worst price. Thus, electronic exchanges provide a depth of liquidity. Moreover, electronic exchanges allow buyers and sellers to enter bids and offers at prices that are better than the BBO, thus improving the price that a counterparty would receive for the instrument.

Known electronic commerce websites offer very limited opportunities for a seller or buyer to achieve price improvement or accurate price discovery when compared with electronic exchanges for financial instrument. Typical on-line auctions allow bidders to compete with one another for a particular item currently up for bid. Separate items are sold in isolated transactions. On-line auctions do not provide deep liquid markets where similar goods by multiple sellers can be purchased by buyers wishing to pay a “market” price.

In addition, on known electronic commerce websites when an auction by one seller ends another seller, in a separate transaction, may offer the same item. Depending on the population of willing buyers at the time of the second auction the seller may receive a different price for the same item. Thus, the process of “price discovery” available from exchanges such as those used to trade financial instruments that would define the market for an item is not available on known electronic commerce sites. The present invention provides systems and methods to overcome the deficiencies in the prior art.

### BRIEF SUMMARY OF THE INVENTION

The invention relates to creation of an online market for retail goods that functions like an exchange for financial securities. Such a market allows seller to benefit from improved price discovery and can provide deep, liquid markets for buyers and sellers. Such a market also benefits buyers by providing a comparison of total net price for a given product.

According to one embodiment, a non-transitory computer-readable medium storing a computer program is disclosed that, when executed on a computer performs processing, the program comprising the steps of receiving one or more quotations to sell a quantity of an item from one of a plurality of sellers, wherein the quotations comprise price information and quantity information; storing seller information for each of the plurality of sellers, wherein seller information comprises seller location information; receiving a buy search from a buyer comprising a buy quantity of the item; storing buyer information, wherein buyer information comprises electronic address information and buyer location information; calculating a total price per item for one or more quotations to sell as a function of the buy search, the buyer information, and the seller information; ranking the one or more quotations to sell based on total price per item; and providing the buyer with the total price per item for one or more quotations to sell.

In connection with the above embodiment, disclosed is an alternative embodiment wherein the program causes the steps of storing one or more buy orders, wherein each of the one or more buy orders comprises a limit price, ranking the one or more buy orders based on the limit price; and providing to a seller, the ranked one or more buy orders.

In connection with the above embodiment is another alternative embodiment, the program causes steps of matching one or more buy orders with one or more quotations to sell based on the calculated total price per item of the one or more quotations, wherein the limit price of a matched buy order is less than or equal to a corresponding total price per item of a matching quotation.

According to another alternative embodiment the program causes the steps of storing one or more gift card items, wherein each of the one or more gift card items comprise retailer information, purchase price information, and redemption value information; and providing the buyer with the total price per item for the one or more quotations to sell based on one or more gift card items.

According to another alternative embodiment, the program causes the calculation of the total price per item for the one or more quotations to sell as a function of sales tax and a shipping cost, wherein the shipping cost is computed based on the buyer location.

According to another alternative embodiment, the seller information includes a seller rating.

According to another alternative embodiment, the buyer information includes a buyer rating.

According to another alternative embodiment, the program causes the steps of filtering the ranked quotations based on a seller rating, a buyer rating, a total cost, a maximum quantity to buy a minimum quantity to buy, a seller location, a delivery time, a minimum quantity to sell, or a maximum quantity to sell.

According to another alternative embodiment, the quotation to sell includes a required buyer rating.

According to another alternative embodiment, the program causes the calculation of shipping cost based on aggregating items to ship in a single box.

According to another alternative embodiment, the step of ranking of quotations includes ranking based on an arrival time.

According to another alternative embodiment, the quotation to sell is a market order to sell, and the program causes the determination of a quantity of the items to sell to a buyer providing the seller with a highest proceed per item, and a remaining quantity of the items to sell to a second buyer providing the seller with a next highest proceed per item.

According to another alternative embodiment, the quotation to sell remains a valid offer to sell until canceled.

According to another alternative embodiment, the quotation to sell includes an expiration date.

Additionally, according to another embodiment, a non-transitory computer-readable medium storing a computer program is disclosed that, when executed on a computer, causes the computer to perform the steps of: storing seller information for one or more sellers, wherein seller information comprises seller location information and an electronic seller address; storing buyer information, wherein buyer information comprises electronic address information and buyer location information; receiving one or more orders to buy a requested quantity of an item from one of a plurality of buyers, wherein each of the one or more buy orders comprises a limit price; storing one or more buy orders; receiving a sell inquiry from a specific one of the sellers comprising an item to sell and an available quantity; calculating a total proceed and a total proceed per item for the specific seller based on the seller information, the buyer information, the available quantity, and the requested quantity; ranking the one or more buy orders based on the limit price; and providing to a seller, the ranked one or more buy orders.

In accordance with the above embodiment, disclosed is an alternative embodiment, wherein the program causes the steps of receiving an order to sell from the specific seller, wherein the order to sell is associated with a buyer that provides the seller with the highest proceed per unit.

According to another alternative embodiment, the program causes the steps of recommending an order to sell to the specific seller, wherein the order to sell comprises recommending selling to a buyer that provides the seller with a highest proceed per unit.

According to another alternative embodiment, the program causes, in response to receiving an order to sell from the specific seller, determination of a quantity of the items to sell to a buyer that provides the seller with a highest proceed per unit, and the determination of a remaining quantity of the items to sell to a second buyer to provide the seller with a next highest proceed per unit.

Additionally, According to another alternative embodiment, a non-transitory computer-readable medium storing a computer program is disclosed that, when executed on a computer, causes the program to perform the steps of storing seller information for each of a plurality of sellers, wherein seller information comprises seller location information; storing buyer information, wherein buyer information comprises electronic address information and buyer location information; receiving a quotation to sell a quantity of an item from one of the plurality of sellers, wherein the quotations comprise price information and quantity information; storing the quotation to sell; receiving one or more buy orders for a requested quantity of an item from one of a plurality of buyers, wherein each of the one or more buy orders comprises a limit price and quantity information; storing the buy orders; calculating a total price per item based on the quotation to sell, a buy order, the buyer information, and the seller information; and matching the buy order with the quotation to sell when the calculated total price per item of the quotation to sell is less than or equal to the limit price.

According to another alternative embodiment, the program causes the determination that the order to sell is an insufficient quantity, and causes the steps of calculating a total price per item of the requested quantity based on two or more quotations to sell; and matching the multiple quotations to sell with the buy order when the total price per item based on the two or more quotations is less than or equal to the limit price.

Although the invention is of general applicability, particular attention is given herein to the application of the invention to creating a dynamic, exchange-like online market for retail goods.

### BRIEF DESCRIPTION OF THE DRAWINGS

Embodiments of the invention are illustrated in the figures of the accompanying drawings, which are meant to be exemplary and not limiting, and in which like references are intended to refer to like or corresponding things.

FIG. 1 shows a flowchart of an exemplary embodiment.

FIG. 2 is a block diagram of a representative prior art computer.

FIG. 3 is a block diagram of representative prior art interconnected networks.

FIG. 4 shows a flowchart relating to receiving seller information.

FIG. 5 show a flowchart relating to receiving buyer information.

FIG. 6 shows how an offer price is calculated.

FIG. 7a shows an exemplary output showing how offers to sell are ranked.

FIG. 7b shows an exemplary output showing a second buyer's perspective of ranked offers to sell.

FIG. 8 shows an exemplary output of a seller's view of resting buy orders.

FIG. 9 shows a flowchart detailing completion of a sale.

FIG. 10 shows a flowchart detailing order matching.

FIG. 11 shows an embodiment using gift card buying/trading.

FIGS. 12a and 12b shows an exemplary transaction using gift card buying/trading.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The use of the terms “a”, “an”, “at least one”, “one or more”, and similar terms indicate one of a feature or element as well as more than one of a feature. The use of the term “the” to refer to the feature does not imply only one of the feature and element.

When an ordinal number (such as “first”, “second”, “third”, and so on) is used as an adjective before a term, that ordinal number is used (unless expressly or clearly specified otherwise) merely to indicate a particular feature, such as to distinguish that particular feature from another feature that is described by the same term or by a similar term.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate). Similarly, where more than one device, article or other product is described herein (whether or not they cooperate), a single device/article may alternatively be used in place of the more than one device or article that is described. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

The present invention will now be described in detail on the basis of exemplary embodiments.

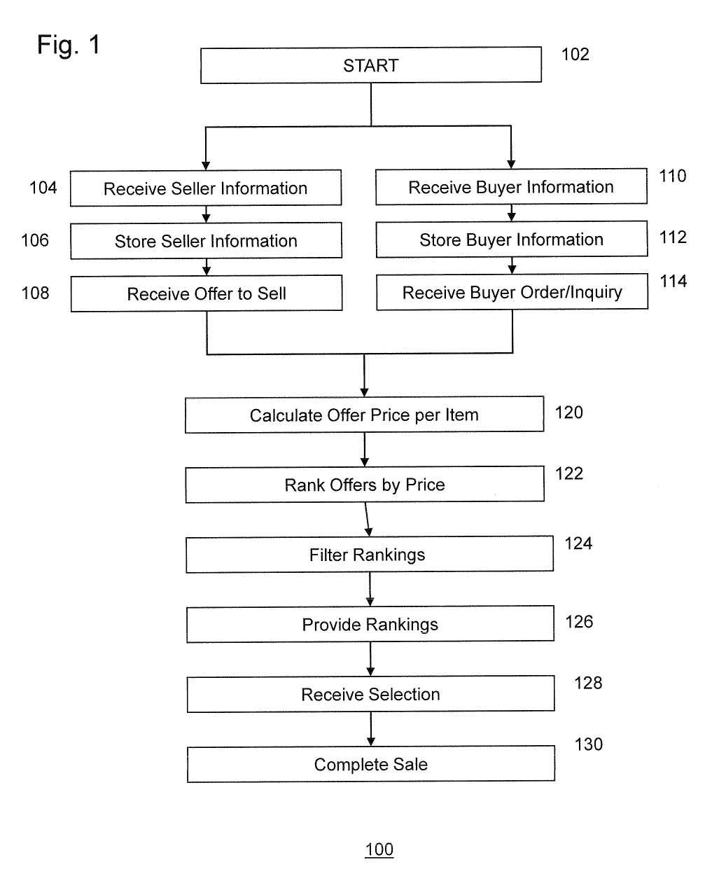

FIG. 1 shows a flowchart illustrating an algorithm according to an exemplary embodiment. The algorithm is a series of steps, program code, or software typically stored in a computer readable medium that may be executed at a server or other processing device to implement the present invention. Step 102 of flowchart 100 is the start. The device executing the program receives seller information in step 104. After receiving seller information, the device stores seller information in step 106. After storing seller information, the device may receive an offer to sell from a seller in step 108. Additionally, after start up, the device may receive buyer information in step 110. After receiving buyer information, the device may store buyer information in step 112. After storing buyer information, the device may receive a buyer inquiry or a buy order in step 114.

When the device has one or more offers to sell an item and has received a buyer inquiry or a buy order, the device calculates a price per item in step 120. The price per item is determined based on a quantity of the item specified in the buy order or the buy inquiry, seller information such as location, buyer information, shipping, any taxes, any discounts available, etc. Once a price per item is calculated, the device ranks the offers to sell by price in step 122. For example, lower price per item may be ranked at the top. Alternatively, the offers may be ranked according to a different measure. For example, the offers may be ranked according to when each offer was received. After the offers are ranked, any applicable filters are applied in step 124. For example, a buyer may choose to filter offers based on a seller rating or a familiarity with specific sellers that the buyer has done business with before, or have been recommended to the buyer.

After the filters have been applied, the device provides the rankings to the buyer in step 126. For example, the device may provide the rankings in a format for display on the buyer's computer monitor or mobile phone screen. The device then receives the buyer's selection in step 128. After receiving the buyer's selection, the device completes the order in step 130.

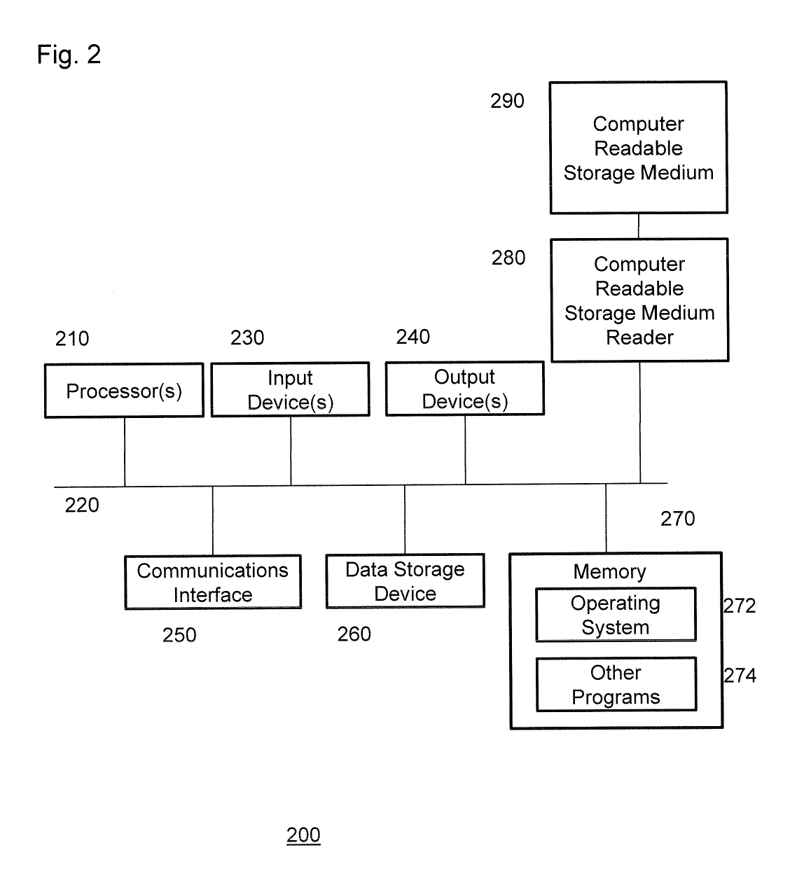

The invention disclosed herein may be practiced using programmable digital computers. FIG. 2 is a block diagram of a representative prior art computer. The computer system 200 includes at least one processor 210, such as an Intel Core™ 2 microprocessor or a Freescale™ PowerPC™ microprocessor, coupled to a communications channel 220. The computer system 200 further includes an input device 230 such as, e.g., a keyboard or mouse, an output device 240 such as, e.g., a CRT or LCD display, a communications interface 250, a data storage device 260 such as a magnetic disk or an optical disk, and memory 270 such as Random-Access Memory (RAM), each coupled to the communications channel 220. The communications interface 250 may be coupled to a network such as the Internet. Moreover, the computer system 140 may be equipped with a browser program suitable for communication with the World Wide Web.

One skilled in the art will recognize that, although the data storage device 260 and memory 270 are depicted as different units, the data storage device 260 and memory 270 can be parts of the same unit or units, and that the functions of one can be shared in whole or in part by the other, e.g., as RAM disks, virtual memory, etc. It will also be appreciated that any particular computer may have multiple components of a given type, e.g., processors 210, input devices 230, communications interfaces 240, etc.

The data storage device 260 and/or memory 270 may store an operating system 272 such as Microsoft Windows 7®, Windows XP® or Vista™, Linux®, Mac OS®, or Unix®. Other programs 274 may be stored instead of or in addition to the operating system. It will be appreciated that a computer system may also be implemented on platforms and operating systems other than those mentioned. Any operating system 272 or other program 274, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 200 may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 280, such as, e.g., a magnetic disk drive, magneto-optical drive, optical disk drive, or flash drive, may be coupled to the communications bus 220 for reading from a computer-readable storage medium (CRSM) 290 such as, e.g., a magnetic disk, a magneto-optical disk, an optical disk, or flash RAM. Accordingly, the computer system 200 may receive programs and/or data via the CRSM reader 280. Further, it will be appreciated that the term “memory” herein is intended to include various types of suitable data storage media, whether permanent or temporary, including among other things the data storage device 260, the memory 270, and the CSRM 280.

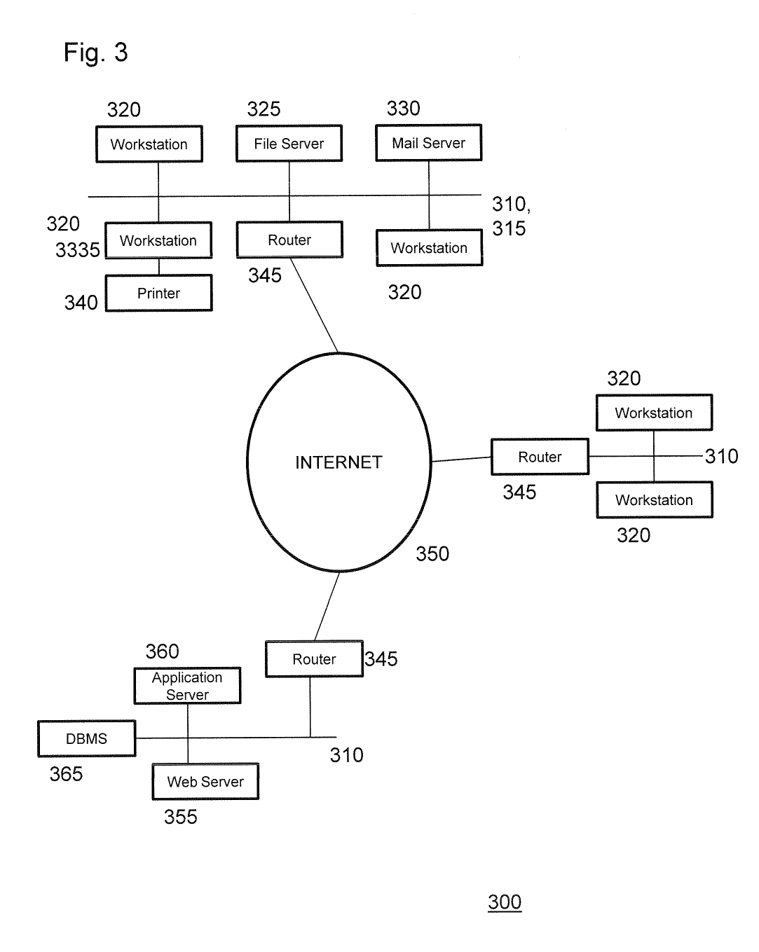

Two or more computer systems 200 may be connected, e.g., in one or more networks, via, e.g., their respective communications interfaces 210 and/or network interfaces (not depicted). FIG. 3 is a block diagram of representative prior art interconnected networks 300, such as may be useful in connection with embodiments of the invention.

A network 315 may, for example, connect one or more workstations 320 with each other and with other computer systems, such as file servers 325 or mail servers 330. The connection may be achieved tangibly, e.g., via Ethernet® or optical cables, or wirelessly, e.g., through use of modulated microwave signals according to the IEEE 802.11 family of standards. A computer system that participates in the network may send data to another computer system in the network via the network connection.

One use of a network 310 is to enable a computer system to provide services to other computer systems, consume services provided by other computer systems, or both. For example, a file server 325 may provide common storage of files for one or more of the workstations 320 on a network 315. A workstation 320 sends data including a request for a file to the file server 325 via the network 315 and the file server 325 may respond by sending the data from the file back to the requesting workstation 320.

As will be recognized by those skilled in the relevant art, the terms “workstation,” “client,” and “server” are used herein to describe a computer's function in a particular context. A workstation may, for example, be a computer that one or more users work with directly, e.g., through a keyboard and monitor directly coupled to the computer system. A computer system that requests a service through a network is often referred to as a client, and a computer system that provides a service is often referred to as a server. But any particular workstation may be indistinguishable in its hardware, configuration, operating system, and/or other software from a client, server, or both.

Further, a computer system may simultaneously act as a workstation, a server, and/or a client. For example, as depicted in FIG. 3, a workstation 335 is connected to a printer 340. That workstation 335 may allow users of other workstations on the network 315 to use the printer 340, thereby acting as a print server. At the same time, however, a user may be working at the workstation 320 on a document that is stored on the file server 325.

A network 315 may be connected to one or more other networks 310, e.g., via a router 345. A router 345 may also act as a firewall, monitoring and/or restricting the flow of data to and/or from a network 310 as configured to protect the network. A firewall may alternatively be a separate device (not pictured) from the router 345

A network of networks 310 may be referred to as an internet. The term “the Internet” 350 refers to the worldwide network of interconnected, packet-switched data networks that uses the Internet Protocol (IP) to route and transfer data. A client and server on different networks may communicate via the Internet 350. For example, a workstation 320 may request a World Wide Web document from a Web Server 355. The Web Server 355 may process the request and pass it to, e.g., an Application Server 360. The Application Server 360 may then conduct further processing, which may include, for example, sending data to and/or receiving data from one or more other data sources. Such a data source may include, e.g., other servers on the same network or a different one and/or a Database Management System (“DBMS”) 365.

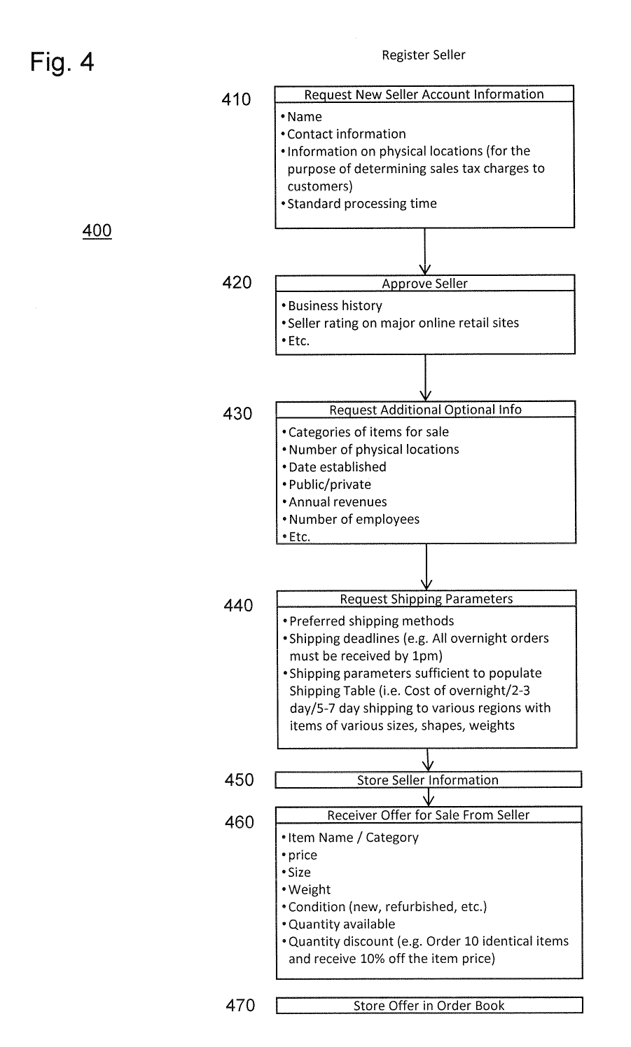

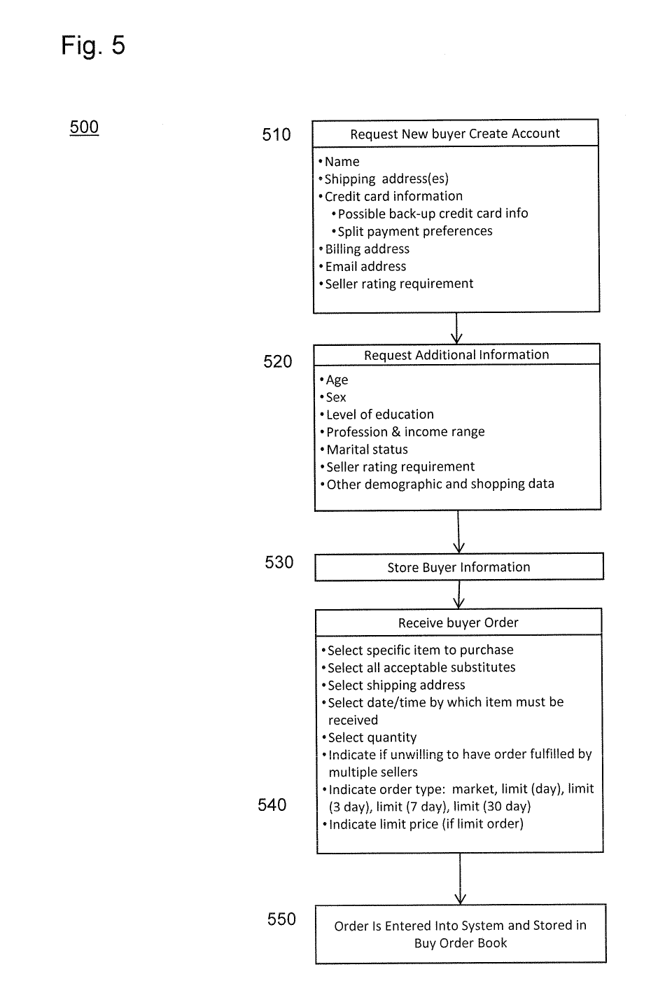

FIG. 4 shows a flowchart illustrating an algorithm according to an exemplary embodiment for receiving seller information and/or registering a seller. The algorithm is a series of steps, program code, or software typically stored in a computer readable medium that may be executed at a server or other processing device to implement the present invention. Upon executing the program, running the application, or requesting and loading a webpage embodying the present invention by a computer device, the device requests a new seller's account information at step 410. The account information may include but is not limited to, the seller's name, the seller's contact information including phone number, a physical address, and a digital address. The physical address may be used for determining sales tax charges and/or shipping charges. The shipping charges may be calculated in conjunction with a buyer's physical address or shipping destination as discussed below with respect to FIG. 5. The device may also request standard processing times. For example, the seller may typically process orders in 2 days at no additional charge, but within 24 hours for an additional charge or the seller may not offer overnight processing and/or delivery.

The device then moves to step 420 where the device determines whether to approve the seller. The device may consider a business history of the seller, may take into account a rating of the seller on online retail sites. After approving the seller, the device requests additional optional information from the seller at step 430. For example, the device may request or the seller may input any categories of items that are or will be for sale, the number and addresses of any physical locations of the items, for example, if the seller stores the items at more than one warehouse, the date the seller's business was established, whether the seller is a private or public business, the annual revenues of the seller, the number of employees, etc.

From step 430, the device moves to step 440 where shipping parameters are requested. The device may request preferred shipping methods, shipping deadlines (e.g. all overnight orders must be received by 1 pm), and other shipping parameters to populate a shipping table, i.e. the cost of overnight shipping, the cost of 2-3 day shipping, the cost of 5-7 day shipping to various regions for various items of various shapes, weights, and sizes. The device stores all seller information at step 450. Alternatively, the seller information is stored after each step or after each piece of seller information is received.

At step 460 the device receives an offer to sell from the seller. The offer may include an item name, an item category, an item price, a size, a weight, a shape, a condition (e.g. new, used, like new), a quantity, and any discounts available at certain quantities. After receiving the offer from the seller, the device stores the offer in an order book. According to one embodiment, each distinct item has its own order book comprising an offer to sell that item from each of a plurality of sellers. According to another embodiment, different, but related items, for example, new, used, or like items of the same type, are stored in a single order book.

FIG. 5 show a flowchart for receiving buyer information. The algorithm is a series of steps, program code, or software typically stored in a computer readable medium that may be executed at a server or other processing device to implement the present invention. Upon executing the program, running the application, or requesting and loading a webpage embodying the present invention, the device requests a new buyer's account information at step 510. The device may request the buyer's name, the shipping address or destination, payment information such as credit card information or bank account information, a back up payment source, split payment preferences, a billing address, an email address, and/or a seller rating requirement. After the device receives the new buyer account information and the account is created, the device may request additional information at step 520. The additional information may include the buyer's age, gender, level of education, profession, income level, marital status, additional seller preferences such as the identity of sellers the buyer has done business with or sellers that been recommended to the buyer, and other demographic or shopping date. At step 530, all the information is stored.

Once an account is created, the device may receive a buy order or an inquiry from the buyer at step 540. The buy order comprises a selection or an input of a specific item or category of item that the buyer wishes to buy or inquire about. The buyer may select whether substitutions are acceptable or which substitutions are acceptable. The buyer may confirm, select, or input a shipping address or destination and a date and/or time that the item or items must be received by. The buyer may select or input a quantity of the item and may indicate if the buyer is willing or unwilling to have the order fulfilled by more than one seller. The buy order may further comprise a type of order, e.g. a market or a limit order. The buyer may also indicate the lifetime of the order, for example, good til canceled (GTC), or for a specified period of time, e.g. one minute, one hour, one day, one week, etc. If a type of limit order is input, the buyer indicates a limit price. After the buyer completes the selections and/or inputs, the order is entered and received by the device and stored in a buy order book in step 550.

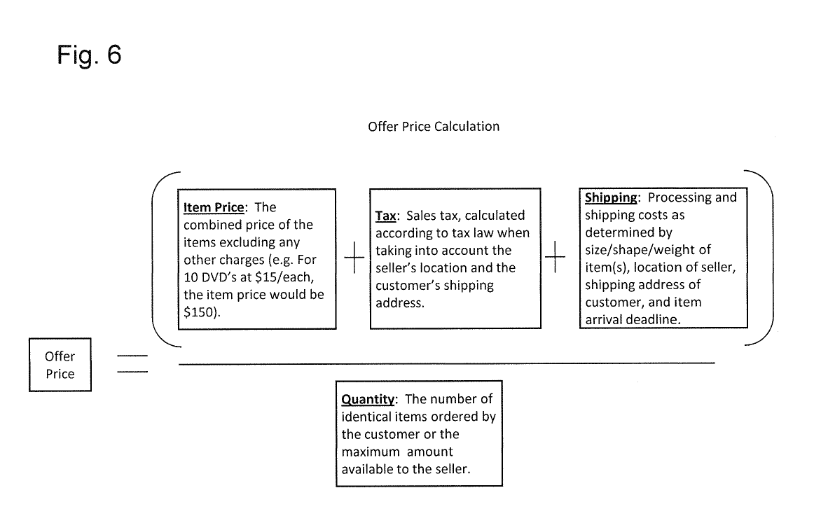

FIG. 6 shows how an offer price is calculated. After a buyer submits a buy offer or submits an inquiry, an offer price is calculated. The offer price may be calculated for each offer to sell submitted by one or more sellers or an offer price may be calculated just for those sellers that meet certain requirements set forth by the buyer. Such requirements may include an available quantity, a minimum seller rating, ability to ship to the buyer's address within a certain period of time, or another criteria set by the buyer. To calculate the offer price for one item, the program divides the item price, which is submitted by the seller, by the quantity, which is submitted by the buyer. When the seller offers a combined price for the purchase of multiple items, the offer price reflects the combined price. For example, if a seller submits an item price of $20 or 10 for $15/each, the total item price for a quantity of 10 would be $150. If the buyer submits a quantity of 10, the offer price is calculated as an item price of $150 divided by a quantity of 10 for result of $15. If, however, the buyer submits a quantity of 5, the offer price is calculated as $100 divided by 5, for a result of $20.

Based on the item, the seller's address, or the buyer's address, tax may be considered. Furthermore, based on the item, the quantity of the item, the item's size, shape, and weight, the seller's address, and the buyer's address, shipping may be factored into the offer price. As FIG. 6 shows, when tax and/or shipping are considered, the offer price is the total item price plus the tax amount plus the shipping costs, divided by the quantity.

Offers may be stored in a sell order book. When an offer is calculated and it is determined to be the lowest offer price, the offer may be compared to standing market orders or limit orders stored in the buy order book. If the offer price is not determined to be the lowest offer, the offer to sell may be ranked and stored in the sell order book. The ranking is dynamic and may be changed according to newly received buy orders, newly received seller orders, or changes to buy information or seller information.

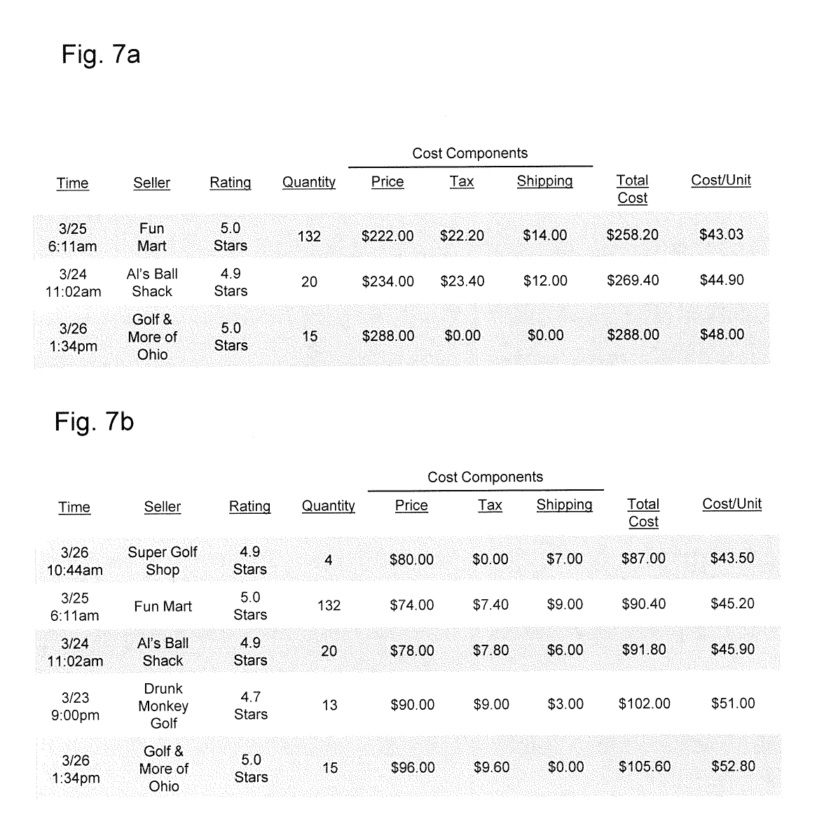

FIG. 7a shows an exemplary output showing how offers to sell are ranked. Specifically, FIG. 7a shows a sample sell order book that would be seen by a customer residing in California that is interested in buying six (6) dozen Titleist Pro V1 golf balls from sellers with ratings of 4.8 stars or better. FIG. 7b shows the same sell order book as viewed by a customer residing in Ohio that is interested in buying two (2) dozen Titleist Pro V1 golf balls from sellers with ratings of 4.6 stars or better. As can be seen, two different buyers are provided with different views of the sell order books based on the buyer's location, requested quantity, and required seller rating. The differences between the two sell order books are that the first buyer was not offered the chance to buy from Super Golf Shop due to the size of his order, because, as shown in FIG. 7a, only sellers with at least the minimum quantity are shown. Furthermore, the first buyer was not offered the chance to buy from Drunk Monkey Golf, due to its lower seller rating, because, as shown in FIG. 7a, only sellers with a minimum seller rating of 4.8 stars are shown. Further still, the first customer had the chance to buy from Golf & More of Ohio without any charge for tax, whereas the second customer (an Ohio resident) would have his options altered by the tax that Golf & More of Ohio would charge.

In one embodiment, each order must be filled entirely by one seller or retailer. However, other embodiments allow the device to allocate an order allowing a combination of sellers including the shipping costs and taxes to fulfill the order. According to an additional embodiment, the device is programmed to calculate shipping charges on purchases of different terms, provided that the items can be shipped together. An additional embodiment allows customers to indicate a range of acceptable substitute products at the specified limit price.

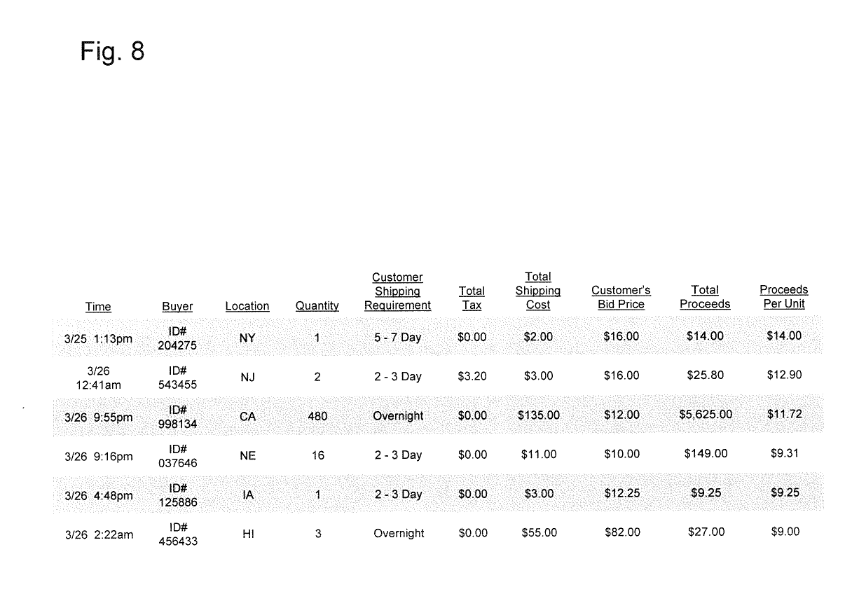

FIG. 8 shows an exemplary output of a seller's view of resting buy orders on the buy order book. In this embodiment, a seller may submit an inquiry regarding resting or fulfilled buy orders. The order book shown in FIG. 8 would be seen by Trenton Videos, a New Jersey retailer, looking to immediately liquidate its inventory of 500 DVD copies of the film “Alvin and the Chipmunks: The Squeakquel.” FIG. 8 shows the resting limit orders that have been entered by customers looking to buy copies of this film. Based on the buy order book, Trenton Videos could sell all 500 DVDs immediately for a total of $5,823.05 (net of shipping and taxes) by entering a market order to sell. Without this ability to price discriminate, had Trenton Videos simply put the DVDs on sale at the single low price necessary to ensure liquidation ($9.25), it would only have made $4,625.00 (net of shipping and taxes).

The completion of a sale according to an embodiment of the invention, will be described. As described with respect to FIGS. 7a, 7b, and 8, potential buyers and sellers are provided with respective sell order books and buy order books. This is shown at step 126 of FIG. 1. One of the buyer or the seller makes a selection as shown in step 128 of FIG. 1. After the device receives the selection, the device completes the sale as shown in step 130 of FIG. 1.

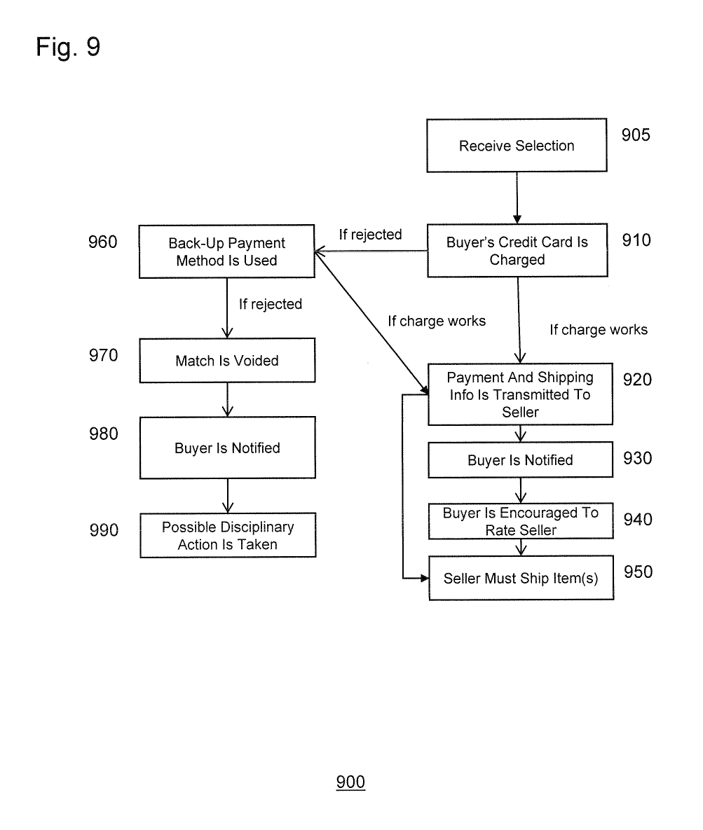

FIG. 9 shows the details of completing the sale. After receiving the selection, the buyer's credit card is charged at step 910. The credit card may be on file with the buyer information or may be input by the buyer at the time of the sale. If the charge successfully completes, notification is sent to the seller at step 920. The notification may include proof of payment, the payment itself, shipping information, and/or other buyer information. Once the seller receives this information, the seller ships the item or items as shown in step 950. After the seller is sent the notification in step 920, the buyer is notified in step 930, and the customer is encouraged to rate the seller in step 940. The buyer may rate the seller right away or may wait until receiving the item or items.

If the charge does not successfully complete in step 910, the program attempts to use a back up payment option in step 960. If the back up payment option is successful, notification is sent to the seller in step 920, who then ships the items. If the back up payment option is rejected, the buy order may be voided, as shown in step 970. The buyer is notified that the payment options failed and that the sale did not complete in step 980. Disciplinary action may be taken in step 990 for buyer's who place orders and cannot pay. This action may include lowering the buyer's rating, notifying potential sellers that the buyer is unreliable, or the like.

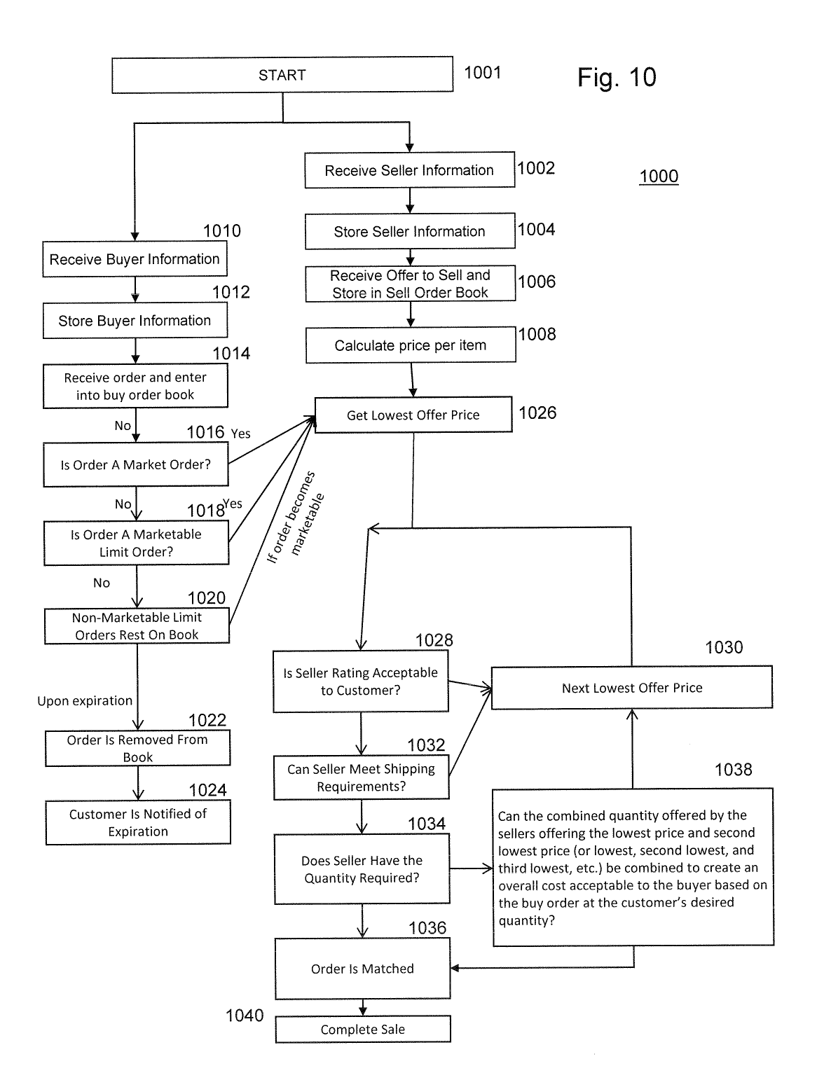

FIG. 10 shows a flowchart illustrating an algorithm according to an exemplary embodiment for order matching. The algorithm is a series of steps, program code, or software typically stored in a computer readable medium that may be executed at a server or other processing device to implement the present invention. The device starts at step 1000 where program execution commences. The device receives seller information at step 1002 and then stores the seller information at step 1004. Steps 1002 and 1004 may be repeated any number of times depending on the number of sellers. At step 1006, the device receives an offer to sell an item from a seller. Step 1006 may be repeated multiple times for each of a plurality of potential sales from one or more sellers. Once a offer to sell is received the device calculates a price per item at step 1008. The device receives buyer information at step 1010 and then stores the received buyer information at step 1012. Steps 101 and 1012 may be repeated any number of times depending on the number of potential buyers. The buyer then submits a buy order. The device enters the buy order into the buy order book at step 1014. If the device has received at least one offer to sell and a market order to buy, the device retrieves the lowest offer price related to the offer to buy in step 1026. Alternatively, if the device receives an offer to buy which is not a market order, the device moves to step 1018 and determines if the offer is a marketable limit order. If, based on the calculated price per item, the limit order is marketable, the device moves to step 1026 and retrieves the lowest offer price. If, however, the buy order is not a market order, and is not a marketable limit order, the non-marketable limit order rests on the buy order book. When an offer to sell is submitted making the non-marketable limit order marketable, the device moves to step 1026 where the lowest offer price is retrieved. In cases where the lifetime of the buy order expires for non-marketable limit order before an offer to sell is submitted which would allow a non-marketable limit order to be marketable, the limit order is removed from the buy order book in step 1022. The customer is notified that the limit order expired in step 1024.

As described above in step 1026, the device has received a market order or marketable limit order and the device retrieves the lowest offer price. The device then determines whether the rating of the seller submitting the lowest offer meets the buyer's requirements in step 1028. If the seller rating is determined to be acceptable, the device determines if the seller can meet the buyer's shipping requirements in step 1032. However, if the device determines that the seller does not meet the buyer's requirements, the device moves to step 1030 where the next lowest offer price is retrieved. In a step not shown in FIG. 10, the device determines if the buy order is marketable at this next lowest offer price. And again, if it determined that the seller does not meet the buyer's requirements, the device moves to step 1030. In step 1032, if it is determined that the seller does meet the buyer's shipping requirements, the device determines whether the seller has the ability to sell the requested quantity in step 1034. If the seller can meet the buyer's quantity requirement, the order is matched in step 1036 and the sale is completed in step 1040.

If it is determined that the seller does not meet the buyer's quantity requirements, the device determines if the combined quantity offered by multiple sellers, including, for example, the sellers offering the lowest price and second lowest price (or lowest, second lowest, and third lowest, etc.) be combined to create an overall cost making the buy order marketable. If multiple orders can be combined to fulfill the buy order, the device moves to step 1036, where the order is matched and then to step 1040, where the order is completed.

In another embodiment according to the invention, a gift card platform may be used independently or in conjunction with the above processes. Gift cards are monetary instruments that enable a user to purchase goods or services up to the value of the card and may be issued by specific retailers (e.g. Home Depot or The Gap) or banks (American Express) and may be redeemable at specific retailers or for specific items (e.g. Levi Jeans). In addition to conventional use of gift cards as cash-equivalent gifts, gift cards may also be sold on a secondary market generally at a discount below face value of the gift card. A seller offers to sell a gift card with a face value of X amount of dollars for an amount less than X dollars. For example, a seller may hold three $100 gift cards from The Gap, but instead, would rather have cash. By offering to sell the 3 $100 gift cards for $80 each, the seller receives $240 in cash and a buyer, gets $300 worth of merchandise for $240.

Gift cards may be purchased and sold just as other items are purchased and sold according to the processes described according to the present invention. Gift card sellers submit seller information and offers for sale as described with respect to FIGS. 1, 4, and 6. Likewise, potential gift card buyers submit buyer information and buy orders or inquiries, as described with respect to FIGS. 1, 5, and 9. The transaction resulting in matching an offer to sell a gift card and an order to buy a gift card is accomplished as described with respect to FIG. 10. A gift card seller order book including resting offers to sell gift cards results when offers to sell gift cards without marketable order to purchase gift cards. Alternatively, as will be described more fully below, the device may not accept direct orders to purchase. Instead, the sell order book of gift cards may be used to create a gift card platform according to an embodiment of the invention.

Incorporating the gift card platform into the general processes described above in FIGS. 1, 4, 5, 6, and 9 may be accomplished by way of a gift card platform according to the invention to determine the offer price. The gift card platform is made available to the device when calculating a total price of another item.

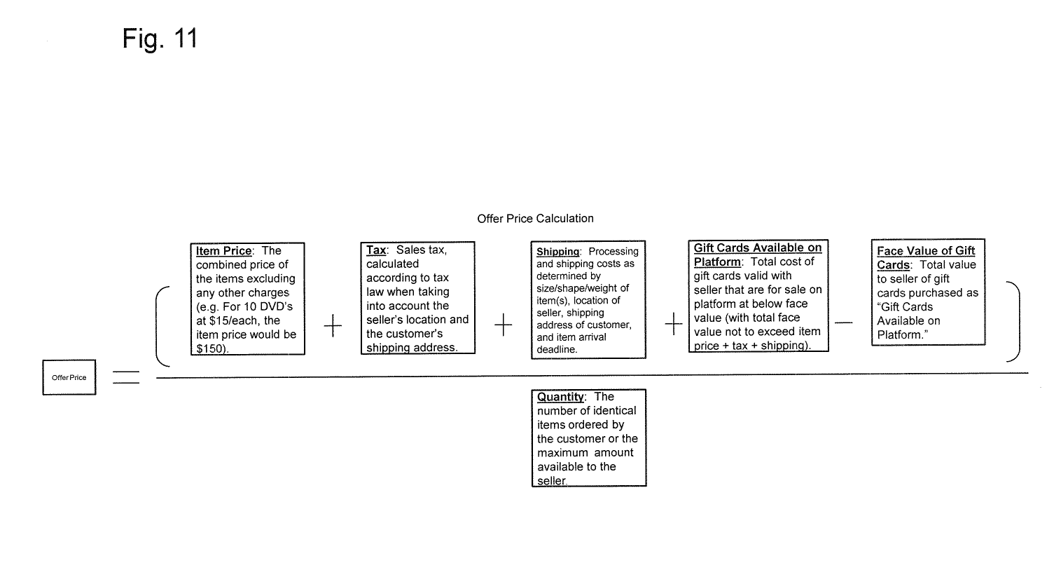

FIG. 11 shows how the offer price is calculated when the gift card platform is incorporated. The offer price is the item price+tax+shipping+a total cost of gift cards valid with the seller that are for sale on the platform at below face value. Thus, the discount on the value of the gift cards are used to offset the total price to the buyer.

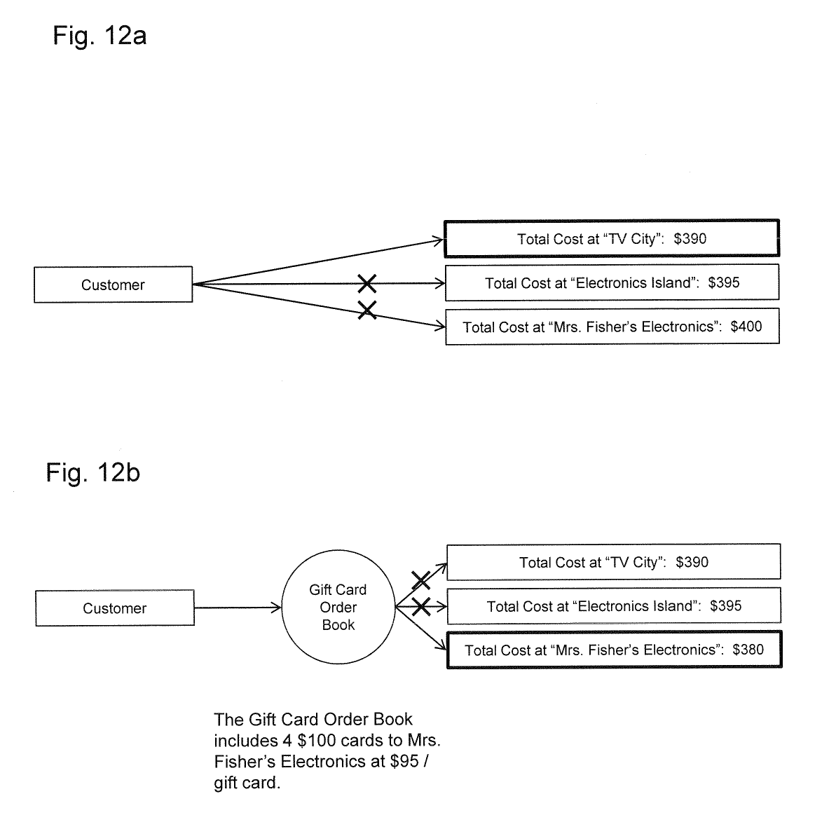

FIGS. 12a and 12b show an embodiment of the invention using gift card buying/trading to complete purchases. If a buyer wishes to purchase a television, the system according to an embodiment of the invention uses the gift card trading/buying platform to find, not only the least expensive way to acquire the television inclusive of shipping and taxes, but the least expensive way inclusive of other discounts as well.

In the example shown in FIG. 12a, the buyer may purchase a television from “TV City” based on a system incorporating the device found in FIGS. 1, 3, 4, 5, 6, 9, and 10. However, in an alternative embodiment where a gift card trading/buying platform is used, the gift card platform is consulted in the process of completing a purchase.

FIG. 12b shows that four $100 gift cards for “Mrs. Fisher's Electronics” are available on the platform for $95 each. According to an embodiment of the invention, the device calculates a total cost of the three offers for sale from “TV city”, “Electronics Island”, and “Mrs. Fisher's Electronics” by assuming that the buyer first purchases the three discounted Mrs. Fisher's gift cards and then uses these gift cards to offset the cost of the purchase. By linking the television seller order book with the gift card order book the buyer can save $10 over the next best offer by purchasing the television from “Mrs. Fisher's Electronics.” The customer need not know that four gift cards were purchased and used in the process.

While the invention has been described and illustrated in connection with preferred embodiments, many variations and modifications as will be evident to those skilled in this art may be made without departing from the scope of the invention, and the invention is thus not to be limited to the precise details of methodology or construction set forth above, as such variations and modification are intended to be included within the scope of the invention. Therefore, the scope of the appended claims should not be limited to the description and illustrations of the embodiments contained herein.

1. A non-transitory computer-readable medium storing a computer program that when executed on a computer performs processing, the program comprising the steps of:
receiving by the computer executing the program one or more quotations to sell a quantity of an item from one of a plurality of sellers, wherein the quotations comprise price information and quantity information;
storing by the computer executing the program seller information for each of the plurality of sellers, wherein seller information comprises seller location information;
receiving by the computer executing the program a buy search from a buyer comprising a buy quantity of the item;
storing by the computer executing the program buyer information, wherein buyer information comprises electronic address information and buyer location information;
calculating a total price per item for one or more quotations to sell as a function of the buy search, the buyer information, and the seller information;
ranking the one or more quotations to sell based on total price per item; and
providing the buyer with the total price per item for one or more of the quotations to sell.

2. The non-transitory computer-readable medium storing the program according to claim 1, the program further comprising the steps of:
storing one or more buy orders, wherein each of the one or more buy orders comprises a limit price;
ranking the one or more buy orders based on the limit price; and
providing to a seller the ranked one or more buy orders.

3. The non-transitory computer-readable medium storing the program according to claim 2, the program further comprising the step of:
matching one or more buy orders with one or more quotations to sell based on the calculated total price per item of the one or more quotations, wherein the limit price of a matched buy order is less than or equal to a corresponding total price per item of a matching quotation.

4. The non-transitory computer-readable medium storing the program according to claim 1, the program further comprising the steps of:
storing one or more gift card items, wherein each of the one or more gift card items comprise retailer information, purchase price information, and redemption value information; and
providing the buyer with the total price per item for the one or more quotations to sell based on one or more of the gift card items.

5. The non-transitory computer-readable medium storing the program according to claim 1,
wherein the total price per item for the one or more quotations to sell is a function of sales tax and a shipping cost and
wherein the shipping cost is computed based on the buyer location.

6. The non-transitory computer-readable medium storing the program according to claim 1, wherein the seller information further comprises a seller rating.

7. The non-transitory computer-readable medium storing the program according to claim 1, wherein the buyer information further comprises a buyer rating.

8. The non-transitory computer-readable medium storing the program according to claim 1, the program further comprising the step of:
filtering the ranked quotations based on a seller rating, a buyer rating, a total cost, a minimum quantity to buy, a minimum quantity to sell, a seller location, a delivery time, a maximum quantity to buy, or a maximum quantity to sell.

9. The non-transitory computer-readable medium storing the program according to claim 1, wherein a quotation to sell comprises a required buyer rating.

10. The non-transitory computer-readable medium storing the program according to claim 5, wherein the shipping cost is computed based on aggregating items to ship in a single box.

11. The non-transitory computer-readable medium storing the program according to claim 1, wherein the ranking of quotations includes rankings based on an arrival time.

12. The non-transitory computer-readable medium storing the program according to claim 2, wherein a quotation to sell is a market order to sell,
wherein a quantity of the items are sold to a buyer providing the seller with a highest proceed per item, and
wherein a remaining quantity of the items are sold to a buyer providing the seller with a next highest proceed per item.

13. The non-transitory computer-readable medium storing the program according to claim 1, wherein a quotation to sell remains a valid offer to sell until canceled.

14. The non-transitory computer-readable medium storing the program according to claim 1, wherein a quotation to sell comprises an expiration time.

15. A non-transitory computer-readable medium storing a computer program that when executed on a computer performs processing, the program comprising the steps of:
storing seller information for one or more sellers, wherein seller information comprises seller location information and an electronic seller address;
storing buyer information, wherein buyer information comprises electronic address information and buyer location information;
receiving one or more orders to buy a requested quantity of an item from one of a plurality of buyers, wherein each of the one or more buy orders comprises a limit price;
storing one or more buy orders;
receiving a sell inquiry from a specific one of the sellers comprising an item to sell and an available quantity;
calculating a total proceed and a total proceed per item for the specific seller based on the seller information, the buyer information, the available quantity, and the requested quantity;
ranking the one or more buy orders based on the limit price; and
providing to one or more of the sellers the ranked one or more buy orders.

16. The non-transitory computer-readable medium storing the program according to claim 15, the program further comprising the step of:
associating an order to sell from the specific seller with a buy order, wherein the order to sell is associated with the buy order that provides the seller with the highest proceed per unit.

17. The non-transitory computer-readable medium storing the program according to claim 15, the program further comprising the step of:
receiving an order to sell from the specific seller, wherein a first quantity of the items are sold to a buyer that provides the seller with a highest proceed per unit, and wherein a remaining quantity of the items are sold to provide the seller with a next highest proceed per unit.

18. A non-transitory computer-readable medium storing a computer program that when executed on a computer performs processing, the program comprising the steps of:
storing seller information for each of the plurality of sellers, wherein seller information comprises seller location information;
storing buyer information, wherein buyer information comprises electronic address information and buyer location information;
receiving a quotation to sell a quantity of an item from one of a plurality of sellers, wherein the quotations comprise price information and quantity information;
storing the quotation to sell;
receiving one or more buy orders for a requested quantity of an item from one of a plurality of buyers, wherein each of the one or more buy orders comprises a limit price and quantity information;
storing the one or more buy orders;
calculating a total price per item based on the quotation to sell, the buy orders, the buyer information, and the seller information; and
matching the one or more buy orders with the quotation to sell when the calculated total price per item of the quotation to sell is less than or equal to the limit price.

19. The non-transitory computer-readable medium storing the program according to claim 18, the program further comprising the steps of
when the order to sell is an insufficient quantity, calculating a total price per item of the requested quantity based on two or more quotations to sell; and
matching the multiple quotations to sell with the buy order when the total price per item based on the two or more quotations is less than or equal to the limit price.

20. A system for performing a multi-party transaction by a processor controlled by programming instructions comprising:
a retail sales device implemented by the processor, the retail sales device receiving an offer to sell one or more retail items from an item seller at a sale price;
a gift card platform implemented by the processor, the gift card platform receiving an offer from a card seller to sell one or more gift card items, wherein the one or more gift card items include corresponding discounted values; and
a pricing engine implemented by the processor, the pricing engine determining a net sale price for the items,
wherein the net sale price is determined from the sale price offset by the discounted values of the one or more gift card items.

21. The system of claim 20 further comprising a ranking engine, wherein the retail sales platform receives a plurality of offers to sell retail items and the ranking engine ranks the plurality of offers based on the net sales price.

22. A non-transitory computer-readable medium storing a program for performing multi-party transactions, the program comprising the steps of:
receiving offers to sell one or more retail items from an item seller at an item price;
receiving offers to sell one or more gift card items from a card seller, the one or more gift card items including a face value and a discounted value;
calculating an offer price for the one or more retail items from the item seller, wherein the offer price includes a difference between the face value and the discounted value of the one or more gift card items; and
transmitting sale information about the retail items to a buyer including the offer price.

23. The non-transitory computer readable medium storing the program according to claim 22, the program further comprising the steps of:
receiving payment from the buyer for the one or more retail items at the offer price;
purchasing the one or more gift card items used in calculation of the offer price from the card seller; and
purchasing the one or more retail items from the item seller using, at least in part, the purchased gift card items.

24. The non-transition computer readable medium storing the program according to claim 23, the program further comprising the step of providing the one or more retail items to the buyer.

25. The non-transition computer readable medium storing the program according to claim 22, wherein the retail item seller and the gift card item seller are the same entity.

26. The non-transition computer readable medium storing the program according to claim 22 wherein each of the one or more gift card items comprise retailer information, purchase price information, and redemption value information.

27. A apparatus for performing multi-party transactions, the apparatus comprising:
receiving means for receiving offers to sell one or more retail items from an item seller at an item price and for receiving offers to sell one or more gift card items from a card seller, the one or more gift card items including a face value and a discounted value;
calculating means for calculating an offer price for the one or more retail items from each item seller, wherein the offer price includes a difference between the face value and the discounted value of the gift card items; and
transmitting means for transmitting sale information about the retail items to a buyer including the offer price.

28. The apparatus of claim 33 further comprising:
a receiving means for receiving payment from the buyer for the retail items at the offer price; and
purchasing means for purchasing the gift card items used in calculation of the offer price from the card seller and for purchasing the retail items from the item seller using, at least in part, the purchased gift card items.

29. The apparatus of claim 33, wherein the retail item seller and the gift card item seller are the same entity.

30. The apparatus of claim 33, wherein each of the one or more gift card items comprise retailer information, purchase price information, and redemption value information.

31. A system for performing a multi-party transaction by a processor controlled by programming instructions comprising:
a retail sales device implemented by the processor, the retail sales device receiving a bid to purchase one or more retail items from an item buyer at a sale price;
a gift card platform implemented by the processor, the gift card platform receiving an offer from a card seller to sell one or more gift card items, wherein the one or more gift card items include corresponding discounted values; and
a pricing engine implemented by the processor, the pricing engine determining a net sale price for the one or more retail items, wherein the net sale price is determined from the sale price offset by the discounted value of the one or more gift card items.

32. The system of claim 31 further comprising a ranking engine, wherein the retail sales platform receives a plurality of bids to purchase retail items and the ranking engine ranks the plurality of bids based on net sales prices.

33. A apparatus for performing multi-party transactions, the apparatus comprising:
receiving means for receiving inquiries to purchase one or more retail items from an item buyer and for receiving offers to sell one or more gift card items from a card seller, the one or more gift card items including a face value and a discounted value;
calculating means for calculating an offer price for the one or more retail items inquired about by the item buyer, wherein the offer price includes a difference between the face value and the discounted value of the one or more gift card items; and
transmitting means for transmitting sale information about the retail items to the buyer including the offer price.

34. The apparatus of claim 33 further comprising:
receiving means for receiving payment from the buyer for the retail items at the offer price; and
purchasing means for purchasing the one or more gift card items used in calculation of the offer price from the card seller and for purchasing the retail items from the item seller using, at least in part, the purchased gift card items.
